(19) United States
(12) Patent Application Publication
(10) Pub. No.: US 2007/0035628 A1
(43) Pub. Date: Feb. 15, 2007

(54) Image-capturing device having multiple optical systems

(76) Inventor: Kunihiko Kanai, Nagano (JP)

Correspondence Address: Pamela R. Crocker;Patent Legal Staff, Eastman Kodak Company, 343 State Street, Rochester, NY, 14650-2201, US

(21) Appl. No.: 11/365,252

(22) Filed: Mar. 1, 2006

(30) Foreign Application Priority Data
Aug. 12, 2005 (JP) 2005-234838

(51) Int. Cl. H04N 7/18

(52) U.S. Cl. 348/159

(57) ABSTRACT

An appropriate angle of view for image capturing of an object is set and an image is captured. A digital camera comprises a first image-capturing optical system having a lens and a first image sensor, and a second image-capturing optical system having a lens and a second image sensor. A distance to an object is measured by use of an image of the first image-capturing optical system having a relatively wide angle of view. When the object is detected to fall within an angle of view at a position of distance X, an angle of view of the second image-capturing optical system is automatically controlled to the appropriate angle of view and an image is captured. When a face portion of an object falls within the angle of view of the first image-capturing optical system, an appropriate angle of view corresponding to the face portion is set and the angle of view of the second image-capturing optical system is automatically controlled. An image of the object is captured by use of the second image-capturing optical system.

### FIELD OF THE INVENTION

The present invention relates to an image-capturing device and, more particularly, to adjustment of an angle of view for image-capturing in an image-capturing device having multiple image-capturing optical systems.

### BACKGROUND OF THE INVENTION

Conventionally, techniques are known in which a distance to an object is measured and a focal length of a zoom lens is automatically changed.

For example, Japanese Patent No. 2753495 discloses determination of a zoom ratio by measuring a distance to the object at least at three points including a center, a right side, and a left side of an angle of view for image-capturing, in order to vary the lens to an optimum zoom ratio corresponding to a size and a position of the object in the angle of view for image-capturing.

When a passive auto-focusing method in which phase detection and triangulation are applied is used as the method for measuring the distance to the object for determining the zoom ratio in the method of Japanese Patent No. 2753495, distance information for only a few points can be obtained, because only distance information of the object for one point can be obtained by a pair of sensors. Because of this, the amount of information tends to be insufficient for reliably calculating an appropriate angle of view. Meanwhile, in a method of measuring the distance to the object using an auto-focusing of a contract detection method using an image-capturing element in a digital camera (hill-climbing AF), although distance information for a sufficient number of points can be obtained, because the distance is measured by means of the zoom lens itself which is to be controlled, the zoom lens must be temporarily set at the wide end and the appropriate angle of view can be calculated only after the zoom lens is once set at the wide end, and thus, there is a disadvantage that the control requires some amount of time.

### SUMMARY OF THE INVENTION

The present invention advantageously provides an image-capturing device in which an appropriate angle of view corresponding to the object can be easily and reliably set and an image can be captured.

According to one aspect of the present invention, there is provided an image-capturing device comprising a first image-capturing optical system, a second image-capturing optical system, a calculating unit which calculates an appropriate angle of view for an object from an image of a relatively wide angle of view obtained by the first image-capturing optical system, and a control unit which controls an angle of view of the second image-capturing optical system to the appropriate angle of view calculated by the calculating unit and captures an image.

According to another aspect of the present invention, preferably, in the image-capturing device, the calculating unit comprises a unit which detects an object distance at a plurality of points or in a plurality of areas within the image, and a unit which calculates the appropriate angle of view on the basis of a distribution of the object distance.

According to another aspect of the present invention, preferably, in the image-capturing device, the calculating unit comprises a unit which detects a characteristic portion which is unique to an object within the image and a unit which calculates the appropriate angle of view on the basis of the characteristic portion.

According to the present invention, because an appropriate angle of view is calculated by use of an image of a wide angle of view of the first image-capturing optical system and the angle of view of the second image-capturing optical system is controlled to the appropriate angle of view, an angle of view corresponding to an object can be reliably set and there is no necessity for temporarily setting the zoom lens to the wide end as in a case of an image-capturing device having a single image-capturing optical system.

### BRIEF DESCRIPTION OF THE DRAWINGS

Preferred embodiments of the present invention will be described in detail by reference to the drawings, wherein:

FIG. 1 is a block diagram showing a structure of a digital camera;

FIG. 2 is a diagram for explaining setting of an angle of view when a person is the object;

FIG. 3 is a diagram for explaining setting of an angle of view when two people are the object;

FIG. 4 is a diagram for explaining setting of an appropriate angle of view when two people are the object;

FIG. 5 is a diagram for explaining setting of an appropriate angle of view using a face portion of a person;

FIG. 6 is a flowchart of processing according to a preferred embodiment of the present invention;

FIG. 7 is a diagram for explaining setting of an angle of view when an object is moving;

FIG. 8 is a flow chart of processing according to another preferred embodiment of the present invention;

FIG. 9A is a diagram exemplifying an appropriate angle of view before an object is moved; and

FIG. 9B is a diagram exemplifying an appropriate angle of view after an object is moved.

### DETAILED DESCRIPTION OF THE INVENTION

Preferred embodiments of the present invention will now be described by reference to the drawings.

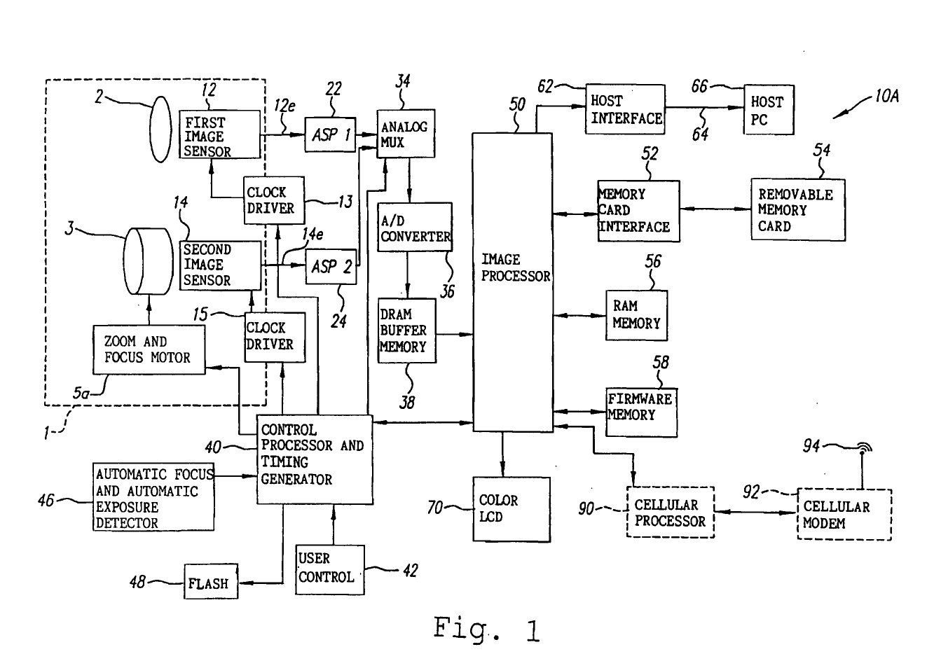

FIG. 1 is a block diagram showing the structure of a digital camera 10A according to a preferred embodiment of the present invention. The digital camera 10A is a portable camera which is driven by a battery. The digital camera 10A produces a still digital image which is stored in a removable memory card 54. The digital camera 10A may produce a motion digital image in addition to or in place of the still image. The motion digital image is similarly stored in the memory card 54.

The digital camera 10A comprises an image-capturing assembly 1 which includes a fixed focal length lens 2 which forms an image of a scene on a first image sensor 12 and a zoom lens 3 which forms an image of the scene on a second image sensor 14. The image-capturing assembly I provides a first image signal 12e output from the first image sensor 12 and a second image signal 14e output from the second image sensor 14. The image sensors 12 and 14 are image sensors having the same aspect ratio and the same pixel size. The lens 2 is, for example, an ultra-wide angle lens having a 35 mm film equivalent focal length of 22 mm, and the zoom lens 3 is, for example, a zoom lens having a 35 mm film equivalent focal length of 40 mm-120 mm.

The fixed focal length lens 2 has a diaphragm and a shutter assembly for controlling exposure of the first image sensor 12. The zoom lens 3 is driven by a zoom and focus motor 5a and comprises a diaphragm and a shutter assembly for controlling exposure of the image sensor 14. Alternatively, a zoom lens having the same focal length range or a different focal length range as the zoom lens 3 may be used in place of the fixed focal length lens 2.

The image sensors 12 and 14 are single-chip color mega pixel CCD sensors and use well-known Bayer color filters for capturing color images. The image sensors 12 and 14 have a 4:3 image aspect ratio, and, for example, 3.1 effective mega pixels, and 2048 pixels×1536 pixels.

A control processor and timing generator 40 controls the first image sensor 12 by supplying a signal to a clock driver 13 and controls the second image sensor 14 by supplying a signal to a clock driver 15. The control processor and timing generator 40 also controls the zoom and focus motor 5a and a flash 48 for illuminating a scene. The control processor and timing generator 40 receives a signal from an automatic focus and automatic exposure detector 46. A user control 42 is used for controlling operations of the digital camera 10A.

The first image signal 12e from the first image sensor 12 is amplified by a first analog signal processor (ASP 1) 22 and is supplied to a first input of an analog multiplexer 34 (analog MUX). The second image signal 14e from the second image sensor 14 is amplified by a second analog signal processor (ASP2) 24 and is supplied to a second input of the analog MUX 34. A function of the analog MUX 34 is to select one of the first image signal 12e from the first image sensor 12 and the second image signal 14e from the second image sensor 14 and to supply to subsequent components the selected sensor output from the image-capturing assembly 1.

The control processor and timing generator 40 controls the analog MUX 34 in order to supply an output of the first analog signal processor (ASP 1) 22 or an output of the second analog signal processor (ASP2) 24 to an analog-to-digital (A/D) converter circuit 36. The digital data supplied from the A/D converter 36 are stored in a DRAM buffer memory 38 and are processed by an image processor 50. The process executed by the image processor 50 is controlled by firmware stored in a firmware memory 58 comprising a flash EPROM memory. The processor 50 processes an input digital image file, and the input digital image file is stored in the RAM memory 56 during the processing stages.

Alternatively, there may be employed a configuration in which two A/D converter circuits are respectively connected to the outputs of the first analog signal processor (ASP 1) 22 and the second analog signal processor (ASP2) 24. In this case, the analog MUX 34 is not necessary, and a digital multiplexer is used to select one of the outputs of the A/D converter circuits.

The digital image file processed by the image processor 50 is supplied to a memory card interface 52 which stores the digital image file in the removable memory card 54. The memory card 54 is one type of a digital image storage medium and may be used in a number of different physical formats. For example, the memory card 54 may be applied to a known format such as Compact Flash (registered trademark), smart media, memory stick, MMC, SD, or XD memory card. Other formats such as, for example, a magnetic hard drive, a magnetic tape, or an optical disk may be used. Alternatively, the digital camera 10A may use an internal non-volatile memory such as a flash EPROM. In such a case, the memory card interface 52 and the memory card 54 are not necessary.

The image processor 50 executes various housekeeping and image processing functions including color interpolation by color and tone correction for producing sRGB image data. The sRGB image data are then compressed in JPEG format and are stored in the memory card 54 as JPEG image data. The sRGB image data may also be supplied to a host PC 66 via a host interface 62 such as SCSI connection, USB connection, or FireWire connection. The JPEG file uses the so-called “Exit” image format.

The image processor 50 is typically a programmable image processor and may be a hardwired customized integrated circuit processor, a general-purpose microprocessor, or a combination of the hardwired customized IC processor and the programmable processor.

The image processor 50 also produces a low-resolution thumbnail image. After an image is captured, the thumbnail image is displayed on a color LCD 70. The graphical user interface displayed on the color LCD 70 is controlled by the user control 42.

The digital camera 10A may be part of a camera phone. In such an embodiment, the image processor 50 is connected to a cellular processor 90 which uses a cellular modem 92 in order to transmit the digital image to a cellular network by means of wireless transmission via an antenna 94. The image-capturing assembly 1 may be an integrated assembly including the lenses 2 and 3, the image sensors 12 and 14, and the zoom and focus motor 5a. In addition, the integrated assembly may include the clock drivers 13 and 15, the analog signal processors 22 and 24, the analog multiplexer MUX 34, and the A/D converter 36.

In a digital camera 10A having a first image-capturing optical system including the lens 2 and the first image sensor 12 and a second image-capturing optical system including the lens 3 and the second image sensor 14, the control processor and timing generator 40 and the image processor 50 use the first image signal 12e obtained by the first image-capturing optical system having a relatively wide angle of view when an image of an object is to be captured and detect a distance to the object by a contrast AF (hill-climbing AF). The distance to the object is detected at a plurality of points within an angle of view of the first image-capturing optical system. The control processor and timing generator 40 calculates an appropriate angle of view in the second image-capturing optical system on the basis of a distribution of distances to the object obtained at a plurality of points.

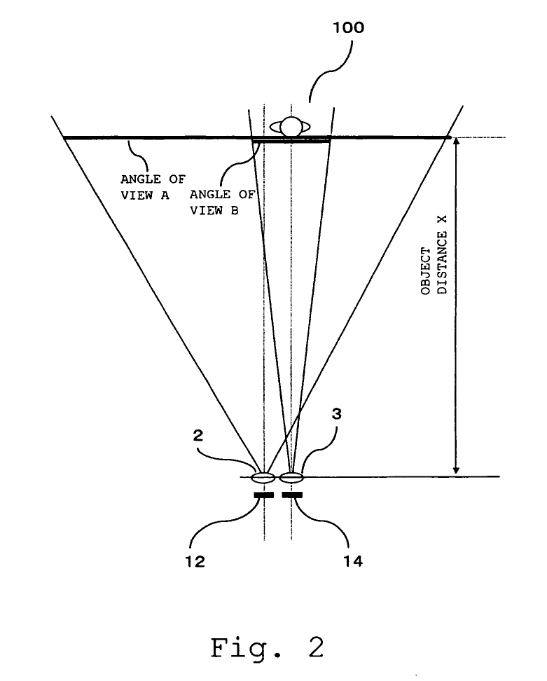

FIG. 2 is a plan view showing a positional relationship among the lens 2 and the first image sensor 12 which are part of the first image-capturing optical system, the zoom lens 3 and the second image sensor 14 which are part of the second image-capturing optical system, and a person who is an object 100. The distance between the digital camera 10A and the person who is the object 100 is assumed to be X. The first image-capturing optical system has an angle of view A which is a relatively wide angle of view and calculates a distance to the object 100 at a plurality of points (or a plurality of areas) within the angle of view A by means of a contrast AF (hill-climbing AF) method. The hill-climbing method is a known method in which data of a contrast are obtained at a certain point, a position of the image-capturing lens is then moved slightly, data of the contrast are again obtained in a similar manner, and, when the contrast improves, the image-capturing lens is moved in the same direction, because the focus position lies in that direction. On the other hand, when the contrast is reduced the image-capturing lens is moved in the reverse direction, because the focus position lies in the reverse direction. These processes are repeated until the contrast is maximized. When the contrast is maximized, the distance to the object 100 is calculated on the basis of the position of the image-capturing lens and the focal length at that point. When the result of detection of the distance to the object 100 in this manner shows that the object 100 falls within a range of an angle of view B at a position of distance X, the zoom and focus motor 5a is driven so that the angle of view of the zoom lens 3 of the second image-capturing optical system matches the angle of view B. After the angle of view of the zoom lens 3 is automatically controlled to the angle of view B, an image of the object 100 is captured by means of the second image-capturing optical system. When a plurality of objects are present in the angle of view A, a distribution is created in the measured values of distance when the distance is measured at a plurality of points in the angle of view A. The closest distances among the measured distance data are determined as the primary measured distance data of the object 100, and an angle of view which includes the data of the closest distances is set as the appropriate angle of view B.

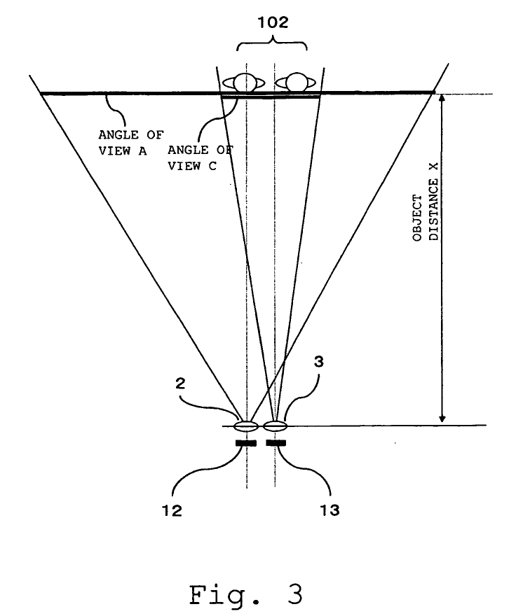

When a plurality of people (for example, two people) are present as an object 102 as shown in FIG. 3, the camera operates in a similar manner. Specifically, when a result of detection of the distance to the object 102 shows that the object 102 falls within a range of an angle of view C at a position of distance X, the zoom and focus motor 5a is driven so that the angle of view of the zoom lens 3 of the second image-capturing optical system matches the angle of view C. After the angle of view of the zoom lens 3 is automatically controlled to the angle of view C, an image of the object 102 is captured by means of the second image-capturing optical system.

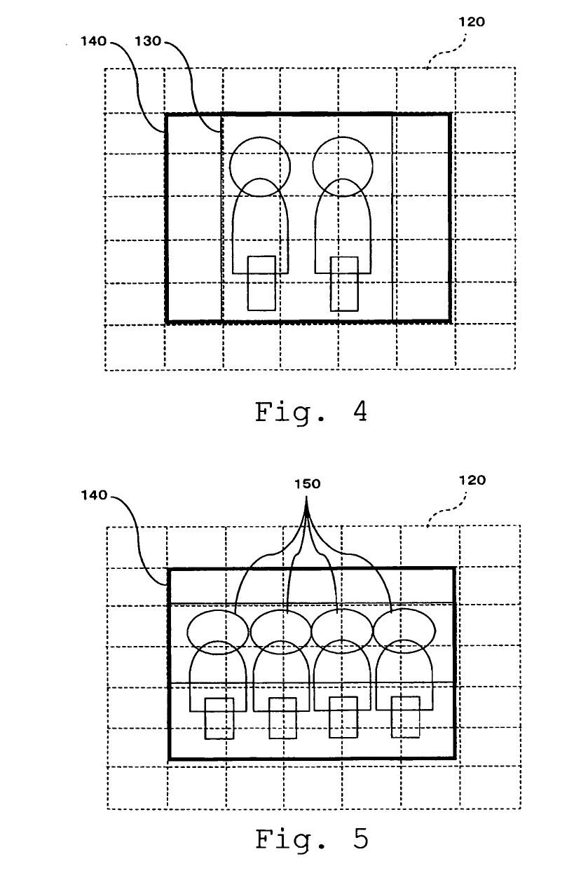

FIG. 4 schematically shows a calculation process of the appropriate angle of view. A rectangular region 120 shown in FIG. 4 with a dotted line represents an angle of view of the first image-capturing optical system having a relatively wide angle of view. Two people are shown in the wide angle of view 120. The wide angle of view 120 is divided into a plurality of distance measurement areas, and distance data are obtained in each distance measurement area through contrast AF (hill-climbing AF). In the distribution of the distance data, a group of closest distance data is created around the region in which the two people are present, and there is temporarily calculated a rectangular region 130 in which the group of the closest distance data fit. A rectangular region 140 in which a predetermined margin (offset) is added to the temporarily calculated rectangular region 130 is calculated as the ultimate appropriate angle of view 140. For example, a distance (size) L from the center of the angle of view to a position of the farthest pixel among the pixels corresponding to the closest distances is calculated, a constant coefficient C (C>1) is multiplied by the calculated size L to obtain C·L, and the size of the appropriate angle of view is calculated from the value of C·L and the length of the diagonal of the angle of view. The coefficient C may be stored in a memory in the digital camera 10A as a default value or may be set or variably adjusted by the user using the user control 42 in a suitable manner. Alternatively, it is also possible to employ a configuration in which the temporarily calculated angle of view 130 is set as the ultimate appropriate angle of view. In other words, it is sufficient to calculate, as the appropriate angle of view, a rectangular region which circumscribes or includes the primary objects at the closest distances.

Alternatively, instead of retrieving a group of closest distance data from a distribution of the distance data, it is also possible to employ a configuration in which a characteristic portion of the object is extracted and the appropriate angle of view is calculated. The characteristic portion of the object may be extracted from, for example, brightness and color of the image-capturing mode (image-capturing scene). For example, when the image-capturing mode is set to “portrait” or the like and a person clearly falls within the angle of view A, a face portion of the person is extracted as the characteristic portion of the object. An algorithm for recognizing a face portion is known. A predetermined face shape, a hair region, a skin-colored region, a region of two eyes, a region of the lips, etc., are detected and the face portion is extracted from relative positional relationship among these regions. Then, as shown in FIG. 5, a rectangular region 140 which circumscribes or includes the face portion 150 is calculated as the appropriate angle of view 140. More specifically, a distance from the center of the angle of view to an edge of the face portion which is farthest away is calculated, the calculated size M is multiplied by a constant coefficient C to obtain C·M, and the size of the appropriate angle of view is calculated on the basis of the value of C·M and the length of the diagonal of the angle of view. When the value of the coefficient C is set to 1.0, the face fills the angle of view in the horizontal direction. When it is desired to include a portion other than the face in the angle of view in order to balance the image, the coefficient C may be set at a value of, for example, 1.2 or the like. The value of the coefficient C may be built in the camera as a default value or may be set to an arbitrary value by the user through manual setting or the like. Alternatively, the setting of the coefficient C may be varied by the camera on the basis of the distance to the object in the group of distance data. For example, when a plurality of faces are detected and there is a person near the camera and a person far from the camera, the angle of view may be set by ignoring the person who is far to determine that the person near the camera is the object. In this manner, the appropriate angle of view excluding the people unrelated to the object can be set. When the image-capturing mode is portrait, the angle of view can be considered to be set with reference to the face portion of the person. Therefore, by calculating the appropriate angle of view with the face portion being the reference, an angle of view satisfying the user's intent can be automatically set.

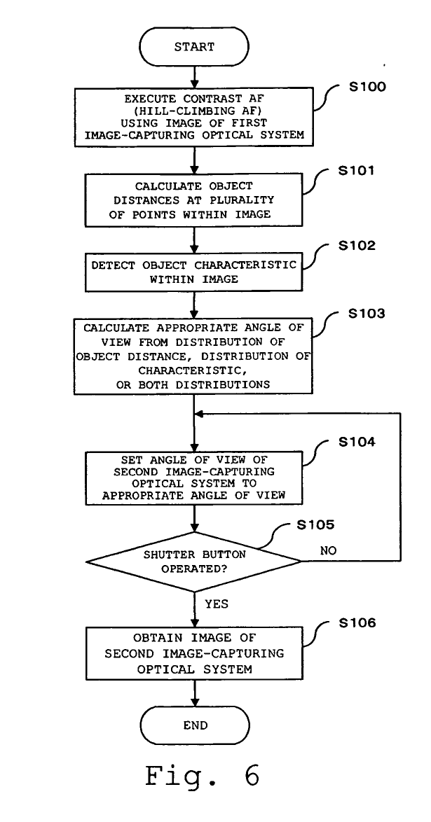

FIG. 6 is a flowchart of processing according to the present embodiment. First, the control processor and timing generator 40 selects the first image signal 12e from the first image sensor 12 of the first image-capturing optical system and supplies the first image signal 12e to the image processor 50. The image processor 50 displays the image of the first image-capturing optical system on the LCD 70 and, at the same time, executes the contrast AF (hill-climbing AF) process using the image (S100). By means of the contrast AF, a distance to the object is detected at a plurality of points (or a plurality of areas) in the angle of view of the first image-capturing optical system (S101).

Then, the image processor 50 or the control processor and timing generator 40 detects a characteristic of the object within the angle of view (S102) and calculates the appropriate angle of view from the distribution of the object distance or the distribution of the characteristics, or a combination of the two distributions (S103). Alternatively, it is also possible to determine the image-capturing mode in the process of step S102 and to extract the characteristic portion of the object in accordance with the image-capturing mode.

After the appropriate angle of view of the object is calculated by use of the image of the first image-capturing optical system, the control processor and timing generator 40 drives the zoom and focus motor 5a to move the zoom lens 3 in a fore-and-aft direction to apply a control to match the angle of view of the second image-capturing optical system with the appropriate angle of view calculated in step S103 (S104). It should be noted that, in the processes of steps S101-S104, the user does not manually operate the zoom by operating a zoom button or the like in order to obtain a desired angle of view for capturing an image of the object. In other words, in the present embodiment, so long as the object falls within the angle of view of the first image-capturing optical system, the digital camera 10A automatically calculates the appropriate angle of view and sets the angle of view of the second image-capturing optical system to the appropriate angle of view. Then, when the user operates the shutter button (determination in step S105 is YES), the control processor and timing generator 40 controls the focus by use of the distance data of the closest distances or the characteristic portion of the object and selects the second image signal from the second image sensor 14. The image processor 50 processes the second image signal and stores the processed image signal in the memory card 54 (S106). The image displayed on the LCD 70 may be unchanged from the image of the first image-capturing optical system or may be switched to the image of the second image-capturing optical system after the angle of view of the second image-capturing optical system is automatically controlled to the appropriate angle of view.

In the present embodiment, because the digital camera 10A automatically recognizes the object and zooms to the appropriate angle of view so long as the object falls within the angle of view of the first image-capturing optical system having a relatively wide angle of view, the user does not need to find or search for the object. In addition, when the user attempts to manually adjust the angle of view to the appropriate angle of view by operating the zoom button, adjusting the angle of view is difficult when the zoom speed is too fast. In the present embodiment, such a problem does not occur and the object can be captured quickly.

Although an image of the object can be captured by automatically controlling the angle of view of the second image-capturing optical system to the appropriate angle of view, the angle of view is preferably maintained at the appropriate angle of view even when the object moves. A case when the object moves will now be described.

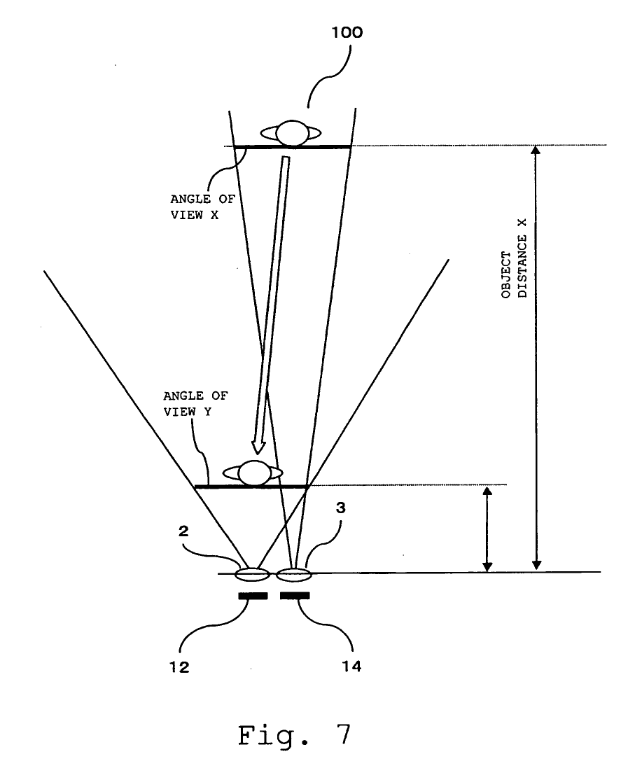

FIG. 7 shows a positional relationship when a person who is the object 100 approaches from a distance X toward the digital camera 10A. The angle of view of the second image-capturing optical system is controlled at the appropriate angle of view X, and, when the object 100 approaches the digital camera 10A from this state, the contrast AF is executed using the image of the second image-capturing optical system to calculate the distance to the object, and the zoom and focus motor 5a is driven so that the angle of view of the approaching object is substantially unchanged. When the object further approaches the digital camera 10A and falls outside the angle of view of the second image-capturing optical system, the control processor and timing generator 40 switches the signal from the second image signal of the second image-capturing optical system to the first image signal of the first image-capturing optical system. The angle of view of the first image-capturing optical system is then automatically controlled to an angle of view Y which is approximately equal to the angle of view X. In this manner, an image-capturing process at the appropriate angle of view can be maintained even when the object moves.

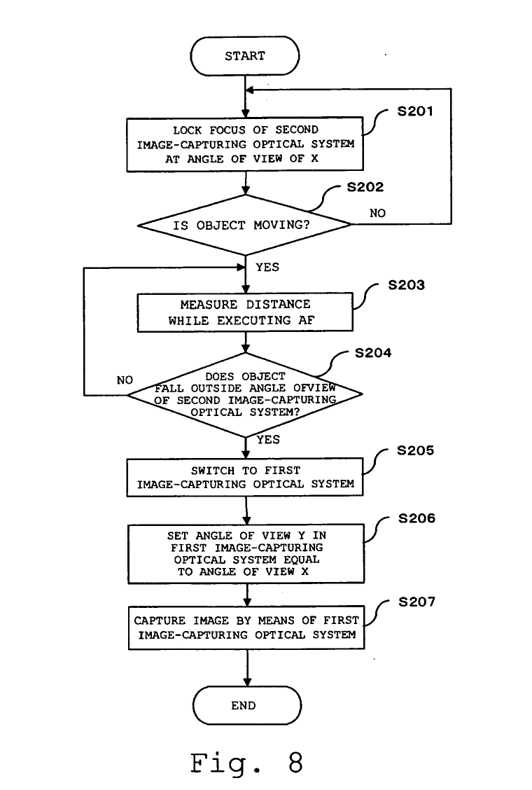

FIG. 8 is a flowchart showing this process. When the angle of view of the second image-capturing optical system is controlled to the appropriate angle of view X and the user presses the shutter button halfway (S1), AF is executed, a distance to the object is detected after AF, and focus is locked at the appropriate angle of view X (S201). Then, the control processor and timing generator 40 determines whether or not the object is moving (S202). The determination as to whether or not the object is moving can be made by calculating a correlation between frames. When the object is moving, the distance to the object is sequentially detected while AF is executed, and the angle of view of the second image-capturing optical system is continuously changed toward the wide side (S203). The above-described related art also discloses a technique for capturing an image by driving the zoom lens according to the distance to the object. In this state, the image processor 50 and the control processor and timing generator 40 determine whether or not the object has moved out of the angle of view of the second image-capturing optical system (S204). The determination as to whether or not the object falls outside the angle of view can be made by calculating the correlation between frames similar to the above. When the object has moved out of the angle of view of the second image-capturing optical system, the control processor and timing generator 40 switches the signal from the second image signal of the second image-capturing optical system to the first image signal of the first image-capturing optical system so that the object is included in the angle of view (S205) and controls the angle of view of the first image-capturing optical system to an angle of view Y which is approximately equal to the angle of view X (S206). When the lens of the first image-capturing optical system is the fixed focal length lens 2, the angle of view Y is obtained by “electronic zoom” as necessary, in which the image of the first image sensor 12 is electronically zoomed. When the shutter is pressed all the way down in this state (S2), the image of the first image-capturing optical system is stored in the memory card 54 (S207).

In this manner, because an image of the object can be captured while the digital camera 10A maintains the appropriate angle of view even when the object moves, the user can reliably capture an image at a desired angle of view even for a moving object. In the above description, the present embodiment has been described by reference to a case when the object moves toward the digital camera 10A. However, the present invention is not limited to such a configuration, and similar processes can be applied when the object moves away from the digital camera 10A. In other words, when the object moves out of the appropriate angle of view X of the first image-capturing optical system, the optical system is switched from the first image-capturing optical system to the second image-capturing optical system, and the angle of view of the second image-capturing optical system is controlled to an angle of view Y which is approximately equal to the angle of view X. When there is a gap between the ranges of the possible angles of view between the first image-capturing optical system and the second image-capturing optical system, the gap is interpolated by means of electronic zoom.

Because the optical system in the present embodiment is switched from the second image-capturing optical system to the first image-capturing optical system (or from the first image-capturing optical system to the second image-capturing optical system), it is preferable to maintain the angle of view during the switching while correcting the parallax between the first image-capturing optical system and the second image-capturing optical system.

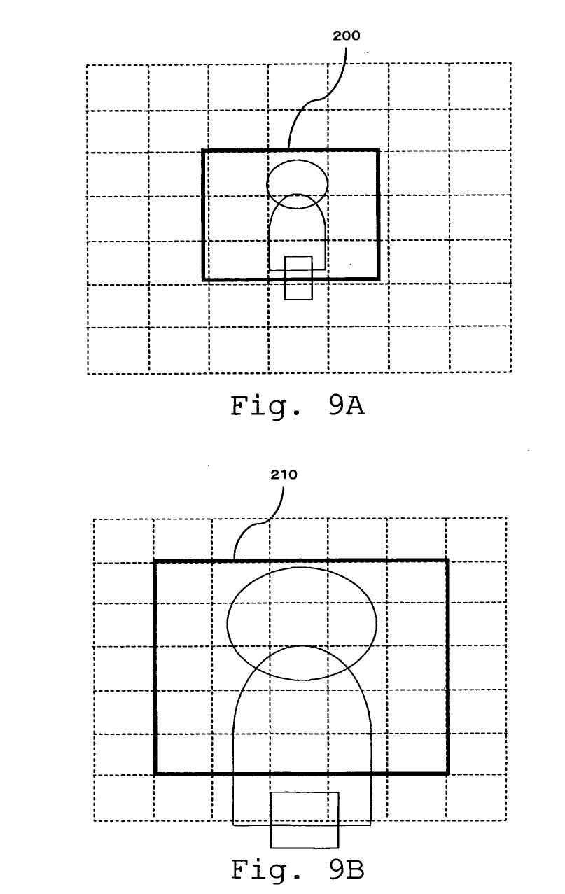

In the present embodiment, the optical system to be used for the image capturing process is switched from the second image-capturing optical system to the first image-capturing optical system when the object moves out of the angle of view X while moving toward the digital camera 10A. Alternatively, it is also possible to shift the angle of view of the second image-capturing optical system toward the wide side without switching between optical systems. FIG. 9A shows an appropriate angle of view 200 calculated from distance information of the object within the angle of view of the first image-capturing optical system, which corresponds to the angle of view X of FIG. 7. When the person who is the object moves toward the digital camera 10A from this state and falls outside the angle of view 200 (or when, on the basis of the amount of movement of the object, the object is expected to move outside the angle of view), the control processor and timing generator 40 re-calculates the appropriate angle of view and once again sets an appropriate angle of view 210.

Preferred embodiments of the present invention have been described. The present invention, however, is not limited to the described embodiments, and various modifications can be made.

For example, regarding the plurality of image-capturing optical systems, the present invention can be applied to an image-capturing device having a combination of a fixed focal length lens and a zoom lens, a combination of zoom lenses having the same focal length range, and a combination of zoom lenses having different focal length ranges. In the configuration with a combination of zoom lenses having the same focal length range, for example, the angle of view of the first image-capturing optical system can be doubled to calculate the appropriate angle of view of the object, and the angle of view of the second image-capturing optical system can be automatically controlled to the appropriate angle of view.

The process of the present invention can be executed according to halfway pressing of the shutter button by the user (S1) or according to a setting of “angle of view matching mode” provided on the digital camera 10A. The user operates on the shutter button or the “angle of view matching mode” so that the user can capture an image of the object at an angle of view appropriate for the object by merely pointing the digital camera 10A toward the object.

In the present embodiment, the digital camera 10A calculates the appropriate angle of view, and the angle of view for image capturing is automatically controlled. Alternatively, it is also possible to provide an operation unit which allows a user to finely adjust the appropriate angle of view which is set by the digital camera 10A and, in this case, it is preferable that, when the appropriate angle of view is finely adjusted by the user by means of the operation unit, the control processor and timing generator 40 learns the fine adjustment and reflects the adjustment in the next process of setting the appropriate angle of view (customization of appropriate angle of view). Specifically, the coefficient C may be adjusted (increased or decreased) according to an amount of operation of the operation unit.

The image-capturing device may also be configured such that, when a characteristic portion of the object is extracted and the appropriate angle of view is set, the user can select, from several basic patterns, a characteristic portion which forms a basis for the calculation of appropriate angle of view, and input and set the characteristic portion.

### PARTS LIST

1 image-capturing assembly
2 fixed focal length lens
3 zoom lens
5a focus motor
10A digital camera
12 first image sensor
12e first image signal
13 clock driver
14 second image sensor
14e second image signal
15 clock driver
22 first analog signal processor
24 second analog signal processor
34 analog multiplexer MUX
36 A/D converter circuit
38 DRAM buffer memory
40 processor and timing generator
42 user control
46 exposure detector
48 flash
50 image processor
52 memory card interface
54 memory card
56 RAM memory
58 firmware memory
66 host PC
62 host interface
70 color LCD
90 cellular processor
92 cellular modem
94 antenna
100 object
102 object
120 rectangular region
130 rectangular region
140 rectangular region
150 face portion
200 angle of view
210 angle of view

What is claimed is:

1. An image-capturing device having multiple optical systems, the image-capturing device comprising:
a first image-capturing optical system;
a second image-capturing optical system;
a calculating unit which calculates an appropriate angle of view for an object from an image of a relatively wide angle of view obtained by the first image-capturing optical system; and
a control unit which controls an angle of view of the second image-capturing optical system to the appropriate angle of view calculated by the calculating unit and captures an image.

2. An image-capturing device having multiple optical systems according to claim 1, wherein:
the first image-capturing optical system has a first objective lens; and
the second image-capturing optical system has a second lens having an angle of view narrower than that of the first objective lens.

3. An image-capturing device having multiple optical systems according to claim 1, wherein:
the calculating unit comprises:
a unit which detects an object distance at a plurality of points or in a plurality of areas within the image; and
a unit which calculates the appropriate angle of view on the basis of a distribution of the object distance.

4. An image-capturing device having multiple optical systems according to claim 3, wherein:
the calculating unit extracts closest distances of the object distances and calculates a rectangular region which circumscribes or includes the object at the closest distances as the appropriate angle of view.

5. An image-capturing device having multiple optical systems according to claim 1, wherein:
the calculating unit comprises:
a unit which detects a characteristic portion which is unique to an object within the image; and
a unit which calculates the appropriate angle of view on the basis of the characteristic portion.

6. An image-capturing device having multiple optical systems according to claim 5, wherein:
the calculating unit detects a face portion of a person as the characteristic portion.

7. An image-capturing device having multiple optical systems according to claim 1, wherein:
the calculating unit comprises:
a unit which detects a characteristic portion within the image in accordance with an image-capturing mode; and
a unit which calculates the appropriate angle of view on the basis of the characteristic portion.

8. An image-capturing device having multiple optical systems according to claim 1, further comprising:
a unit which detects a movement of the object wherein
the calculating unit calculates the appropriate angle of view on the basis of the movement.

9. An image-capturing device having multiple optical systems according to claim 1, further comprising:
a unit which detects whether or not the object deviates out of an angle of view of the second image-capturing optical system controlled to the appropriate angle of view, wherein:
the control unit comprises a unit which controls an angle of view of the first image-capturing optical system to the appropriate angle of view and captures an image when the object deviates out of the angle of view of the second image-capturing optical system.
